(19) United States
(12) Patent Application Publication
(10) Pub. No.: US 2005/0069128 A1
(43) Pub. Date: Mar. 31, 2005

(54) Data-generating device and data-writing device for FPGA

(75) Inventors: Takeshi Inoue, Osaka-shi (JP); Hiroshi Matoba, Osaka-shi (JP); Ryohei Tanaka, Osaka-shi (JP); Toyokazu Kitano, Osaka-shi (JP)

Correspondence Address: MERCHANT & GOULD PC, P.O. BOX 2903, MINNEAPOLIS, MN, 55402-0903, US

(73) Assignee: DAIHEN CORPORATION, Osaka-shi (JP)

(21) Appl. No.: 10/966,173

(22) Filed: Sep. 29, 2004

(30) Foreign Application Priority Data
Sep. 30, 2003 (JP) 2003-340828

(51) Int. Cl. H04L 9/00

(52) U.S. Cl. 380/42

(57) ABSTRACT

Configuration-wiring information is generated by a function-restricted netlist. A data-writing device writes the generated information to FPGAs. The restriction-lifting section lifts the restriction of the restricted configuration-wiring data. Then, a bit stream is generated based on the configuration-wiring data. The bit stream is encrypted in the encryption section and then decrypted in the decryption section. The decrypted data is written to the FPGA by the data writing section. A dongle stores permitted writing count information contracted with an IP vendor. A remaining writing count is calculated based on the writing count information every time the writing to the FPGA is performed. When the remaining writing count becomes zero, the functional restriction lifting and the decryption are prohibited, so that IP netlist cannot be written to the FPGA.

### BACKGROUND OF THE INVENTION

1. Field of the Invention

The present invention relates to a data-generating device for generating data (“hardware-writable data”) which can be written to an FPGA (Field Programmable Gate Array), wherein the data generation is performed based on the given configuration-wiring data of the inner circuit of the FPGA. The present invention also relates to a data-wiring device for writing the hardware-writable data to FPGAs or other kinds of storage mediums such as read-only memories (ROMs) . Further, the present invention relates to a program for causing a computer to function as the above-mentioned data-generating device or data-writing device, and to a computer-readable storage medium for recording such a program.

2. Description of the Related Art

Recently, reconfigurable hardware such as FPGAs and PLDs (Programmable Logic Devices) is used for constructing a digital signal processing circuit. Such hardware is advantageous for achieving reduction in size, cost and power consumption, for example.

As shown in FIG. 12, an FPGA includes a plurality of local lines 100 arranged in a grid pattern. A plurality of configurable logic blocks (CLBs) 101 are connected to the local lines 100, each being arranged in a rectangular region surrounded by the local lines 100. At each cross point of the local lines 100 is provided a switch matrix (SW) 102 to determine the connection for the vertical and horizontal lines 100. The switch matrices 102 connect the logical cells in the CLBs 101 for providing a circuit having a required function.

The hardware-constituent elements (gates, switches, and the like) of FPGAs are general-purpose products, and the function and the performance of FPGAs are determined by the configuration and wiring of these elements (in other words, determined by the relative placement of the elements and the created current-flow routes for connecting the elements). For producing the desired configuration and wiring of the elements, special data or software is needed. This software is called Intellectual Property (IP) core, or IP for short.

The IP core to be loaded into the FPGA can be produced by the user of the FPGA by himself or herself, or may be obtained as commercially available products from IP vendors. There are many commercially available IP cores designed for specific needs such as communication, image processing, calculation, and the like. For reduction in cost and labor of designing, users often buy an IP core (not having the whole function needed) from IP vendors, while also preparing a self-made IP core. Then, the user combines the purchased IP core and the self-made IP core to produce the functionally complete IP core. This complete IP core is loaded into the FPGA.

FIG. 13 is a flow chart illustrating a procedure in which an IP core is bought from an IP vendor and loaded into an FPGA.

First, a user enters into a provisional contract with an IP vendor for evaluation of the IP core in mind. The contract is made by the user's signing an NDA (non-disclosure agreement). After the provisional contract, the user is supplied with a detailed document about the IP core and a simulation model from the IP vendor (S1). The document and the simulation model are free of charge. The simulation model is software whereby the operation of the FPGA is evaluated by signal waveforms. For this evaluation, the user runs the software of the model on a computer by using the dedicated simulator software.

After functional evaluation (S2) of the simulation model, the user decides whether to purchase the IP core or not (S3). If no (S3: NO), the purchasing procedure ends. If yes (S3: YES), the user negotiates with the IP vendor for the license contract (S4), which relates to the right to use the IP core only for a prescribed kind of products. Taking communication modules for example, the IP core may be applied to FPGAs to be used in a particular type of television sets. Since the IP core is intangible software, the buyer-seller contract of an IP core needs to be established to limit the right of the user of the IP core.

After the license contract has been made between the IP vendor and the user, the IP vendor provides the user with a netlist of the IP core. The netlist is data that describes the connection pattern of the circuit in FPGA in accordance with the EDIF (Electronic Design Interchange Format). Based on the netlist supplied from the IP vendor, the user generates data to be loaded into the FPGA by using a special tool (software). With the data loaded, the FPGA can operate to fulfil the expected function. In the above-mentioned case, the FPGA serves as a functional part used for the TV set.

The tool needed for loading the netlist into an FPGA is provided by the supplier of the FPGA. By using this tool, the user loads the supplied netlist into an FPGA. Then, the user can check the function and performance of the IP core on the actual device, namely, the FPGA (S5). When the checking results are satisfactory, the user installs the IP core into FPGAs to be used in the products specified by the license contract (S6). In such a case, conventionally, the user can apply the IP core any number of times to the specified kind of products since this is not prohibited by the contract (S7). However, if the user wishes to apply the IP core to another kind of products unspecified in the contract (S7: YES), the user should make a new license contract with the IP vendor for that (back to S4). In the above-mentioned case, the user is allowed to apply the IP core to TV sets only, with the initial license contract. Therefore, if the user wishes to use the IP core for e.g. radio receiving sets, the user is required to make a new license contract.

FIG. 14 is a flow chart illustrating a different example of IP core-purchasing procedure between a user and an IP vendor.

Differing from the above-described first example (wherein the user is provided with a simulation model for evaluation of the IP core in mind), the user in this second example makes a provisional contract with the IP vendor to obtain a detailed document and an IP core whose function is partially restricted (S1′). Then the user loads the “function-restricted IP core” to an FPGA for checking the function and performance of the IP core (S2′). When the user finds the restricted IP core satisfactory, then the user purchases the functionally unrestricted IP core (normal IP core) by completing the license contract to replace the function-restricted IP core (S5′). In the second example again, the license contract is made valid by specifying the only product to which the IP core is applied.

FIG. 15 is a block diagram illustrating the procedures according to the second example. In the figure, items provided from the IP vendor are shown in the top raw, the operations conducted by the user in the middle raw, and items managed by the user in the bottom raw.

The user designs the configuration of the circuit in FPGA by using HDL (Hardware Description Language). The design data is converted into a netlist by a computer that operates on a special tool (software). The netlist thus prepared is responsible for part of the functions of the FPGA. The complementary netlist responsible for the remaining functions is bought from the IP vendor through a license contract. Thereafter, the user operates the computer for converting a combination of the self-made netlist and the purchased netlist (function-restricted netlist) into data regulating the configuration and wiring of the circuit in the FPGA. This data (which may be referred to as “place & routed data” in this specification) specifies the connection between the switches and the matrices in the FPGA.

The place & routed data is then converted into an FPGA-downloadable bit stream with the use of a special tool installed into the computer. The bit stream is then downloaded into the FPGA, to give the FPGA the desired function (or almost desired function since part of the function is restricted). Thereafter, the user can check whether or not the FPGA operates properly. When the user decides to adopt the IP core after this performance examination, the user makes a substantive contract with the IP vendor to purchase the normal IP core which is unrestricted in function.

Although a license contract wherein the price for the right to use the IP core is paid at one time according to the kind of the products but regardless of the number of using the IP core is described in the above example, a license contract wherein the price is paid independent of the kind of the products but according to the number of using the IP core may also be used. Further, a normal IP is provided to a user for replacing a function-restricted IP core when a license contract is concluded in the embodiment above, but the netlist designed by using the function-restricted IP core may be provided from the user to the IP vendor and the bit stream subsequently generated by the IP vendor may be provided back to the user.

As the IP core is intangible software, the same IP cores can be downloaded into multiple FPGAs or ROMs for storing the data to be written on the FPGAs. Accordingly, production of functional parts by downloading repeated the same IP cores into multiple FPGAs or ROMs for storing the data to be written on the FPGAs leads to decrease in the cost of the part by the number of parts. From the viewpoint of the IP vendors who provide the IP cores, it is not favorable that the price for the IP core to be provided changes according to the number of using the IP core.

Conventionally, the IP vendors may determine the price of the IP core on supposition that the user complies faithfully with the license contract. However, by the conventional method of paying at one time the price for the use of IP core in a particular product independent of the number of use (“lump sum payment system”), IP vendors tend to set the price at a higher price including the insurance premium, since the vendors cannot prevent unauthorized use by the user after the IP core is provided. Accordingly, the price for the license contract tends to be high.

Considering the freedom in designing and the versatility in application of the FPGAs, FPGAs are also useful for products in high-mix low-volume production, and for those uses who want to use it in these products, it becomes more difficult to use the IP core, because the license contract by the lump sum payment method leads to excessive increase in the cost. Accordingly, these users want a payment system independent of the kind of products but based on the number of using the IP core. But in most cases, IP vendors prefer the lump sum payment system, and therefore it is difficult for the users to conclude a license contract in their favorable form.

In the current social environment surrounding the IP core, there are problems as described above that there is conflict of interest between users and IP vendors and it is difficult for the both parties to share cost merit and make the most use of the IP cores.

In the background of these problems, there is a fact that dedicated tools for converting the netlists of the IP cores into bit streams are available in the market from the FPGA suppliers and anyone can install the IP cores easily into FPGAs by obtaining the IP cores, and thus the IP vendors are forced to provide software only by making a evaluation contract or a license contract with a user.

If it is possible to figure out correctly the number of the user downloading the IP core into FPGAs or the ROMs for storing the data to be written on FPGAs, it is more advantageous from the viewpoint of the IP vendors to set a suitable price for downloading an IP core once into a FPGA or the ROM for storing the data to be written on the FPGA (price per downloading) and sell the IP core at the unit price, for optimizing the product price and making it easier to expand the sales. However, when an IP core is sold only by a contract, users do not always comply with it. For instance, the IP core may be used fraudulently in the products other than those specified in the lump sum payment contract, or it may be copied fraudulently. In light of these adverse situations, the IP vendors are compelled to raise the license contract price for the IP core.

If IP cores are available at reasonable prices, it is advantageous for the users, as the IP cores can be used more easily for high-mix low-volume production. However, if IP vendors continue to provide IP cores under a relatively expensive license contract based on the lump sum payment system, the users may be tempted to break the license contract to apply the IP core (originally allowed for one-purpose use) to two or more different kinds of products for gaining the maximum benefit of the cost.

Accordingly, under the current situations of the IP core supply, it would be desirable that a tool for counting the number of the user's downloading of the IP core into FPGAs (or into ROMs for storing the data to be written on FPGAs) is available, so that the user would have other choice but to comply with the license contract. With such a tool, the IP vendor can monitor whether or not the contract is observed by the user. This contributes to avoid the conflict of interest between IP users and IP vendors, thereby accelerating the spread of the IP cores. However, there are no such tools proposed so far, much less put into practice.

### SUMMARY OF THE INVENTION

The present invention has been proposed for overcoming the conventional problems described above.

According to a first aspect of the present invention, there is provided a data-generating device that generates logic information about an internal circuit of hardware having a reconfigurable internal circuit, the logic information being written to the hardware for causing the hardware to carry out a particular function. The data-generating device comprises: a first information-input section for inputting configuration-wiring information about configuration and wiring of the internal circuit, the configuration-wiring information being prepared in a state where part of the particular function is restricted; a restriction-lifting section for lifting functional restriction of the configuration-wiring information; an information-generating section for generating hardware-writable information based on the configuration-wiring information, the hardware-writable information being written to the hardware after the functional restriction is lifted; an encryption section for encrypting the hardware-writable information; a storage section for storing the encrypted hardware-writable information; a second information-input section for inputting restriction control information being related to permission of restriction lifting for the functional restriction; a judgment section for judging appropriateness of lifting the functional restriction by the restriction-lifting section based on the restriction control information; and a prohibiting section for prohibiting the lifting of the functional restriction by the restriction-lifting section when the judgment section decides that the lifting is impermissible.

Preferably, the restriction control information is stored in a hardware key externally connected to the second information-input section to be inputted to the second information-input section from the hardware key.

Preferably, the restriction control information is stored in a management server placed on a network connected to the second information-input section, the restriction control information being inputted to the second information-input section from the management server by communication.

According to a second aspect of the present invention, there is provided a data-writing device for causing the hardware-writable information generated by the data-generating device according to the first aspect of the present invention to be written to a selected one of the hardware and a storage device separate from the hardware. The data-writing device comprises: a first information-input section for imputing the encrypted hardware-writable information; a decryption section for decrypting the encrypted hardware-writable information; an information-writing section for writing the decrypted hardware-writable information to the selected one of the hardware and the storage device; a second information-input section for inputting decryption control information and permitted writing count information, the decryption control information being related to permission of the decrypting by the decryption section, the permitted writing count information being related to a number of times for the hardware-writable information to be written to the hardware or the storage device; a calculating section for calculating a remaining writing count based on the permitted writing count information, the calculation being performed every time the information-writing section performs writing of the hardware-writable information; a judgment section for judging appropriateness of decryption by the decryption section based on the inputted decryption control information and the remaining writing count; and a prohibiting section for prohibiting the decryption by the decryption section when the judgment section decides that the decryption is impermissible.

Preferably, the data-writing device may further comprise a hardware key and an overwriting section, the hardware key being externally connected to the second information-input section, the overwriting section being provided for overwriting data stored in the hardware key. The hardware key stores the decryption control information and the permitted writing count information both inputted to the second information-input section. The overwriting section is provided for overwriting the permitted writing count information stored in the hardware key with the calculated remaining writing count.

Preferably, the data-writing device may further comprise a transmitting section, wherein the decryption control information and the permitted writing count information both inputted to the second information-input section are stored in a management server placed on a network connected to the second information-input section, and wherein the transmitting section transmits the calculated remaining writing count to the management server for overwriting the permitted writing count information stored in the server with the calculated remaining writing count.

According to a third aspect of the present invention, there is provided a data-writing device for writing logic information about an internal circuit of hardware having a reconfigurable internal circuit, the logic information being written for causing the hardware to carry out a particular function. The data-writing device comprises: a first information-input section for inputting configuration-wiring information about configuration and wiring of the internal circuit, the configuration-wiring information being prepared in a state where part of the particular function is restricted; a restriction-lifting section for lifting functional restriction of the configuration-wiring information; an information-generating section for generating hardware-writable information based on the configuration-wiring information, the hardware-writable information being written to the hardware after the functional restriction is lifted; an information-writing section for writing the hardware-writable information to a selected one of the hardware and a storage device separate from the hardware; a second information-input section for inputting restriction control information and permitted writing count information, the restriction control information being related to permission of restriction lifting for the functional restriction, the permitted writing count information being related to a number of times for the hardware-writable information to be written to the hardware or the storage device; a calculating section for calculating a remaining writing count based on the permitted writing count information inputted to the second information-input section, the calculation being performed every time the information-writing section performs writing of the hardware-writable information; a judgment section for judging appropriateness of lifting the functional restriction by the restriction-lifting section based on the restriction control information and the remaining writing count; and a prohibiting section for prohibiting the lifting of the functional restriction by the restriction-lifting section when the judgment section decides that the lifting is impermissible.

According to a fourth aspect of the present invention, there is provided a data-writing device for writing logic information about an internal circuit of hardware having a reconfigurable internal circuit, the logic information being written for causing the hardware to carry out a particular function. The data-writing device comprises: a first information-input section for inputting configuration-wiring information about configuration and wiring of the internal circuit, the configuration-wiring information being prepared in a state where part of the particular function is restricted; a restriction-lifting section for lifting functional restriction of the configuration-wiring information; an information-generating section for generating hardware-writable information based on the configuration-wiring information, the hardware-writable information being written to the hardware after the functional restriction is lifted; an encryption section for encrypting the hardware-writable information; a storage section for storing the encrypted hardware-writable information; a decryption section for decrypting the encrypted hardware-writable information; an information-writing section for writing the decrypted hardware-writable information to the hardware or a storage device separate from the hardware; a second information-input section for imputing control information and permitted writing count information, the control information being related both to permission of restriction lifting for the functional restriction by the restriction-lifting section and to permission of the decrypting by the decryption section, the permitted writing count information being related to a number of times for the hardware-writable information to be written to the hardware or the storage device; a calculating section for calculating a remaining writing count based on the permitted writing count information every time the information-writing section performs writing of the hardware-writable information; a judgment section for judging appropriateness of the lifting of the functional restriction by the restriction-lifting section and appropriateness of the decrypting by the decryption section based on the control information and the remaining writing count; and a prohibiting section for prohibiting the lifting of the functional restriction by the restriction-lifting section and the decrypting by the decryption section when the judgment section decides that the lifting and the decrypting are impermissible.

Preferably, the data-writing device according to the third or fourth aspect of the present invention may further comprise a hardware key and an overwriting section, the hardware key being externally connected to the second information-input section, the overwriting section being provided for overwriting data stored in the hardware key. The hardware key stores the control information and the permitted writing count information both inputted to the second information-input section. The overwriting section is provided for overwriting the permitted writing count information stored in the hardware key with the calculated remaining writing count.

Preferably, the data-writing device according to the third or fourth aspect of the present invention may further comprise a transmitting section, wherein the control information and the permitted writing count information both inputted to the second information-input section are stored in a management server placed on a network connected to the second information-input section, and wherein the transmitting section transmits the calculated remaining writing count to the management server for overwriting the permitted writing count information stored in the server with the calculated remaining writing count.

According to a fifth aspect of the present invention, there is provided a program for causing a computer to function as an data-generating device that generates logic information about an internal circuit of hardware having a reconfigurable internal circuit, the logic information being written to the hardware for causing the hardware to carry out a particular function. The program causes the computer to perform the functions of: a first information-input section for inputting configuration-wiring information about configuration and wiring of the internal circuit, the configuration-wiring information being prepared in a state where part of the particular function is restricted; a restriction-lifting section for lifting functional restriction of the configuration-wiring information; an information-generating section for generating hardware-writable information based on the configuration-wiring information, the hardware-writable information being written to the hardware after the functional restriction is lifted; an encryption section for encrypting the hardware-writable information; a storage section for storing the encrypted hardware-writable information; a second information-input section for inputting restriction control information being related to permission of restriction lifting for the functional restriction; a judgment section for judging appropriateness of lifting the functional restriction by the restriction-lifting section based on the restriction control information; and a prohibiting section for prohibiting the lifting of the functional restriction by the restriction-lifting section when the judgment section decides that the lifting is impermissible.

According to a sixth aspect of the present invention, there is provided a program for causing a computer to function as a data-writing device for causing the hardware-writable information generated by the data-generating device according to the first aspect of the present invention to be written to a selected one of the hardware and a storage device separate from the hardware. The program causes the computer to perform the functions of: a first information-input section for imputing the encrypted hardware-writable information; a decryption section for decrypting the encrypted hardware-writable information; an information-writing section for writing the decrypted hardware-writable information to the selected one of the hardware and the storage device; a second information-input section for inputting decryption control information and permitted writing count information, the decryption control information being related to permission of the decrypting by the decryption section, the permitted writing count information being related to a number of times for the hardware-writable information to be written to the hardware or the storage device; a calculating section for calculating a remaining writing count based on the permitted writing count information, the calculation being performed every time the information-writing section performs writing of the hardware-writable information; a judgment section for judging appropriateness of decryption by the decryption section based on the inputted decryption control information and the remaining writing count; and a prohibiting section for prohibiting the decryption by the decryption section when the judgment section decides that the decryption is impermissible.

Preferably, the program according to the six aspect of the present invention may further cause the computer to perform the function of a data-overwriting section, wherein the data-overwriting section cooperates with a hardware key that is externally connected to the second information-input section and stores the decryption control information and the permitted writing count information, while the data-overwriting section functions to overwrite the permitted writing count information stored in the hardware key with the calculated remaining writing count.

Preferably, the program according to the six aspect of the present invention may further cause the computer to perform the function of a transmitting section, wherein the transmitting section cooperates with a management server that is placed on a network connected to the second information-input section and stores the decryption control information and the permitted writing count information. The transmitting section transmits the calculated remaining writing count to the management server for overwriting the permitted writing count information stored in the server with the calculated remaining writing count.

According to a seventh aspect of the present invention, there is provided a program for causing a computer to function as a data-writing device for writing logic information about an internal circuit of hardware having a reconfigurable internal circuit, the logic information being written for causing the hardware to carry out a particular function. The program causes the computer to perform the functions of: a first information-input section for inputting configuration-wiring information about configuration and wiring of the internal circuit, the configuration-wiring information being prepared in a state where part of the particular function is restricted; a restriction-lifting section for lifting functional restriction of the configuration-wiring information; an information-generating section for generating hardware-writable information based on the configuration-wiring information, the hardware-writable information being written to the hardware after the functional restriction is lifted; an information-writing section for writing the hardware-writable information to a selected one of the hardware and a storage device separate from the hardware; a second information-input section for inputting restriction control information and permitted writing count information, the restriction control information being related to permission of restriction lifting for the functional restriction, the permitted writing count information being related to a number of times for the hardware-writable information to be written to the hardware or the storage device; a calculating section for calculating a remaining writing count based on the permitted writing count information inputted to the second information-input section, the calculation being performed every time the information-writing section performs writing of the hardware-writable information; a judgment section for judging appropriateness of lifting the functional restriction by the restriction-lifting section based on the restriction control information and the remaining writing count; and a prohibiting section for prohibiting the lifting of the functional restriction by the restriction-lifting section when the judgment section decides that the lifting is impermissible.

According to an eighth aspect of the present invention, there is provided a program for causing a computer to function as a data-writing device for writing logic information about an internal circuit of hardware having a reconfigurable internal circuit, the logic information being written for causing the hardware to carry out a particular function. The program causes the computer to perform the functions of: a first information-input section for inputting configuration-wiring information about configuration and wiring of the internal circuit, the configuration-wiring information being prepared in a state where part of the particular function is restricted; a restriction-lifting section for lifting functional restriction of the configuration-wiring information; an information-generating section for generating hardware-writable information based on the configuration-wiring information, the hardware-writable information being written to the hardware after the functional restriction is lifted; an encryption section for encrypting the hardware-writable information; a storage section for storing the encrypted hardware-writable information; a decryption section for decrypting the encrypted hardware-writable information; an information-writing section for writing the decrypted hardware-writable information to the hardware or a storage device separate from the hardware; a second information-input section for imputing control information and permitted writing count information, the control information being related both to permission of restriction lifting for the functional restriction by the restriction-lifting section and to permission of the decrypting by the decryption section, the permitted writing count information being related to a number of times for the hardware-writable information to be written to the hardware or the storage device; a calculating section for calculating a remaining writing count based on the permitted writing count information every time the information-writing section performs writing of the hardware-writable information; a judgment section for judging appropriateness of the lifting of the functional restriction by the restriction-lifting section and appropriateness of the decrypting by the decryption section based on the control information and the remaining writing count; and a prohibiting section for prohibiting the lifting of the functional restriction by the restriction-lifting section and the decrypting by the decryption section when the judgment section decides that the lifting and the decrypting are impermissible.

Preferably, the program according to the seventh or eighth aspect of the present invention may further cause the computer to perform the function of a data-overwriting section, wherein the data-overwriting section cooperates with a hardware key that is externally connected to the second information-input section and stores the control information and the permitted writing count information, while the data-overwriting section functions to overwrite the permitted writing count information stored in the hardware key with the calculated remaining writing count.

Preferably, the program according to the seventh or eighth aspect of the present invention may further cause the computer to perform the function of a data-transmitting section, wherein the data-transmitting section cooperates with a management server that is placed on a network connected to the second information-input section and stores the control information and the permitted writing count information. The data-transmitting section functions to transmit the calculated remaining writing count to the management server for overwriting the permitted writing count information stored in the server with the calculated remaining writing count.

According to a ninth aspect of the present invention, there is provided a computer-readable recording medium storing the program according to any one of the fifth to eighth aspects of the present invention.

Other features and advantages of the present invention will become apparent from the detailed description given below with reference to the accompanying drawings.

### BRIEF DESCRIPTION OF THE DRAWINGS

FIG. 1 is a diagram illustrating an embodiment of the configuration of a data-writing device according to the present invention by using a computer;

FIG. 2 is a flow chart illustrating a method of providing an IP core by using a dongle and an external storage medium storing a program according to the present invention;

FIG. 3 is a functional block diagram illustrating the internal configuration of a data-writing device according to the present invention;

FIG. 4 is a flow chart illustrating the information-writing procedure performed by the data-writing device according to the present invention;

FIG. 5 is a diagram illustrating a data-writing device according to a second embodiment of the present invention;

FIG. 6 is a diagram illustrating a data-writing device according to a third embodiment of the present invention;

FIG. 7 is a flow chart illustrating the information-writing procedure performed by the data-writing device according to the third embodiment;

FIG. 8 is a diagram illustrating the configuration of a data-generating device according to the present invention;

FIG. 9 is a flow chart illustrating the procedure for generating an encrypted bit stream performed by the data-generating device according to the present invention;

FIG. 10 is a diagram illustrating the configuration of the second data-writing device that writes the encrypted bit stream generated in the data-generating device to an FPGA or ROM;

FIG. 11 is a flow chart illustrating the processing performed by the second data-writing device that writes the encrypted bit stream generated in the data-generating device to an FPGA or ROM;

FIG. 12 is a diagram illustrating an example of the internal configuration of an FPGA;

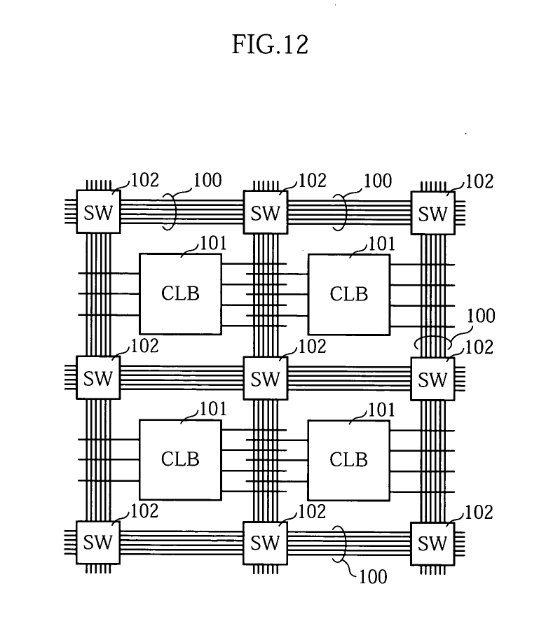

FIG. 13 is a flow chart illustrating a first example of the procedure from purchasing an IP core from an IP vendor to loading the IP core into an FPGA;

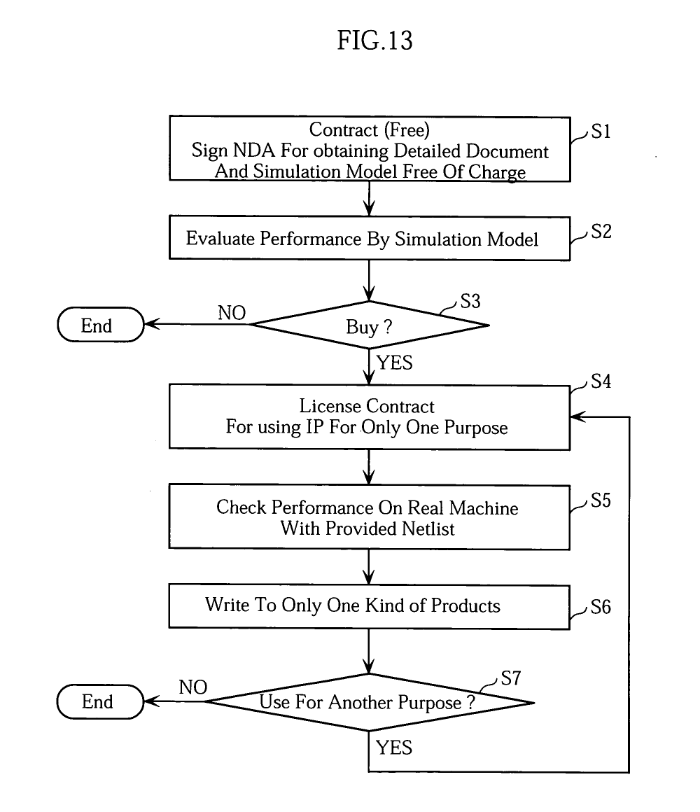

FIG. 14 is a flow chart illustrating a second example of the procedure from purchasing an IP core from an IP vendor to loading the IP core into an FPGA; and

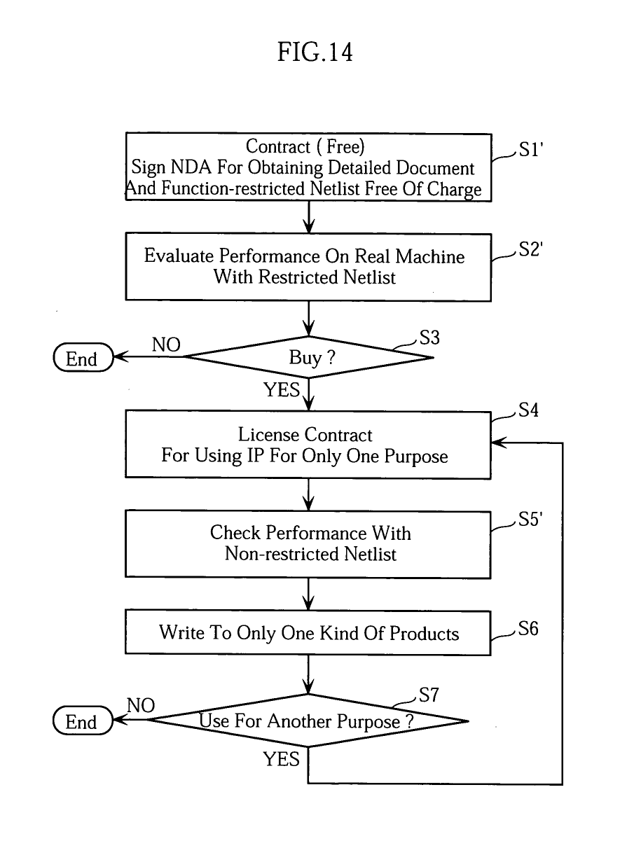

FIG. 15 is a block diagram illustrating the procedure of developing and designing FPGAs in accordance with the purchasing method of the second example.

### DETAILED DESCRIPTION OF THE PREFERRED EMBODIMENTS

Preferred embodiments of the present invention will be described below with reference to the accompanying drawings.

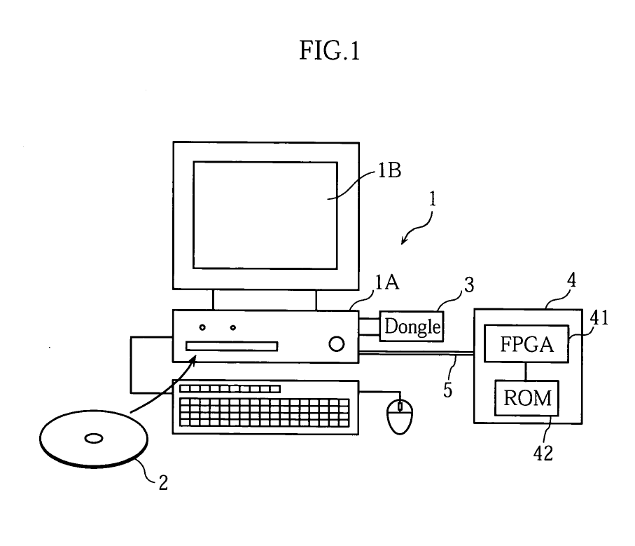

To begin with, a user makes a license contract with an IP vendor to buy an IP core, and this IP core is downloaded into an FPGA (Field Programmable Gate Array). A data-writing device according to the present invention is needed for loading the IP core into the FPGA. The data-writing device is constituted by installing particular software into a personal computer, for example. This software is usually provided from the IP vendor to the user when a contract for sale of the IP core has been made between the IP vendor and the user. As shown in FIG. 1, programs (software) according to the present invention are stored in an external storage medium 2 such as a CD-ROM (compact disc read-only memory), MO (magneto-optical disc), or FD (flexible disc). The user inserts the medium 2 into the driver of a personal computer 1, and then the programs stored in the medium 2 are downloaded into the a RAM (random-access memory) in the computer main body 1A. After the programs are properly installed, the user can use the computer 1 as the data-writing device.

More specifically, the IP vendor usually provides the user with an external storage medium 2 and a dongle (hardware key) 3. The medium 2 stores a program (“FPGA-write-only program”) for writing the IP netlist to the FPGA 41 (or ROM 42). The dongle 3 is provide for protection of the program stored in the medium 2. As shown in FIG. 1, the user downloads the FPGA-write-only program from the external storage medium 2 into its personal computer 1, while also connecting the dongle 3 to a particular parallel or serial port (communication port) of the computer main body 1A. Further, the use connects a board 4 (loaded with the FPGA 41 and the ROM 42) to a particular communication port of the computer main body 1A via a cable 5.

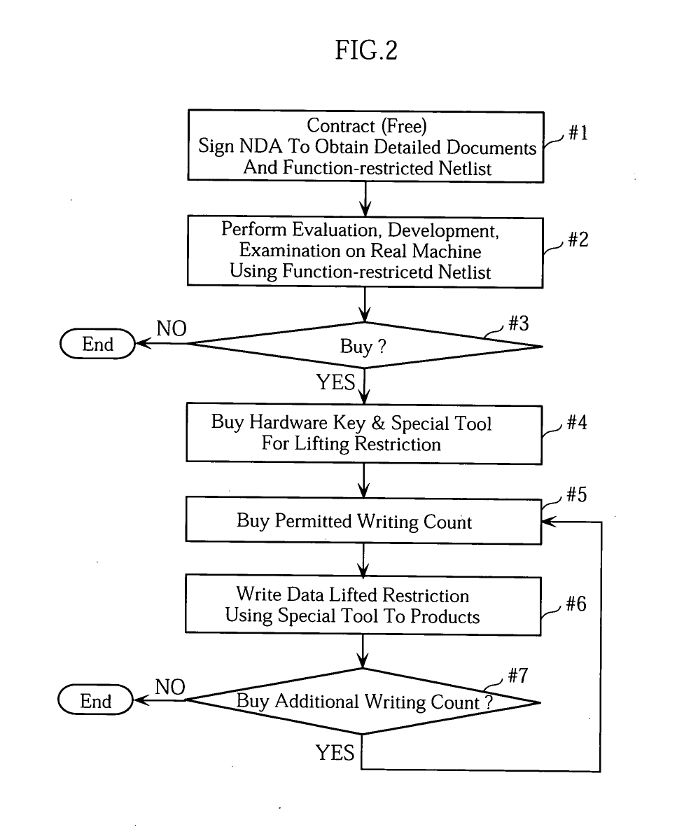

A method of providing the IP core by using the external storage medium 2 and the dongle 3 will be described with reference to the flow chart shown in FIG. 2.

First, the user makes a provisional contract for evaluation of the desired IP core with an IP vendor (#1). For the contract, the user sings a NDA (non-disclosure agreement). Then, the IP vendor provides the user with a detailed document about the IP core (and/or any other informational material), a simulation model, and a netlist of the function-restricted IP core, all of which are free of charge.

The user evaluates the function of the desired IP core by the simulation model. The user also downloads the function-restricted IP core netlist (IP netlist) into the FPGA 41 for evaluating the function and performance of the restricted IP core on a real device or real machine (#2). Then, the user decides whether or not to buy the IP core (#3). If the user does not desire to buy it (#3: NO), the purchasing process ends. If the use desire to buy the IP core (#3: YES), the user buys an external storage medium 2 storing the FPGA-write-only program and a dongle 3 (#4), while also buying a “permitted writing count” for enabling downloading of the IP core into FPGA 41 or ROM 42 a prescribed number of times (#5). The price of the IP core depends on the permitted writing count. Typically, the price of the IP core is in direct proportion to the count.

The permitted writing count is recorded in the dongle 3. The permitted writing count becomes lower by one (1) every time the IP core is downloaded once, and the reduced permitted writing count is recorded in the dongle 3. When the user wishes to write the IP core to the FPGA 41 or ROM 42 by installing the FPGA-write-only program in a personal computer, the current permitted writing count in the dongle 3 may happen to be 0. At this time, the writing of the program is not allowed. In this manner, the writing of the IP core to FPGA 41 or ROM 42 is permitted only up to the permitted writing count of times.

With the external storage medium 2 storing the FPGA-write-only program and the dongle 3, the user makes his or her computer a data-writing, device for FPGAs. Using this data-writing device, the user can download the IP netlist to FPGAs 41 (or ROMs 42) up to the permitted number of times, regardless of the kinds of products for which the FPGAs 41 are used. In this manner, the use can produce his or her desired functional units for the purposes of development, mass production and so forth (#6). If the user wishes to continue using the IP netlist after the permitted writing count becomes zero (#7: YES), the user purchases an additional writing count in Step #5. As the price for the IP core is determined correspondingly to the permitted writing count, the price for the IP core per usage is lower than that by the conventional lump sum payment system. thus, the user can obtain the IP core at a reasonable price.

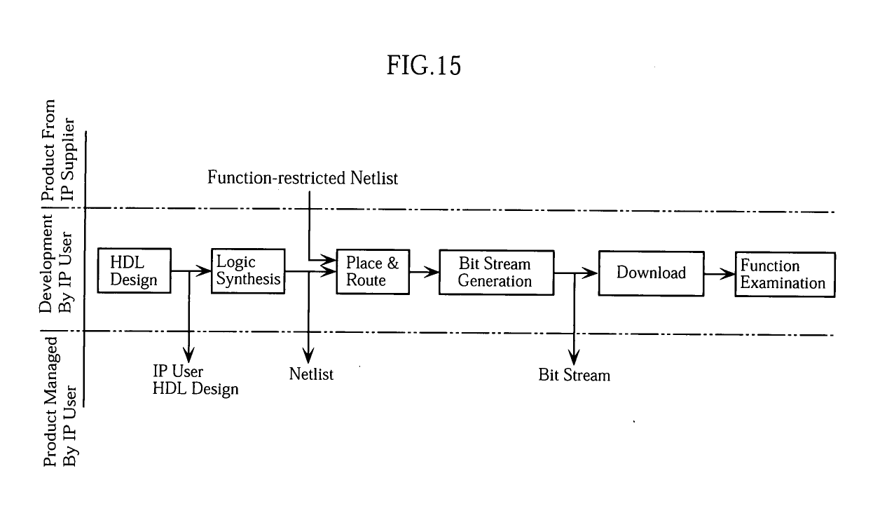

Hereinafter, applications of the data-writing device according to the present invention will be described. In the development and designing procedures of FPGA shown in FIG. 15, the data-writing device generates a bit stream from the configuration and wiring data (place & route data) and downloads the bit stream into FPGA 41 or ROM 42.

Conventionally these procedures are carried out separately by the program exclusive for generating bit streams and program exclusive for downloading the bit streams installed in the user computer. However, the data-writing device of the present invention controls both the generation of a bit stream based on the place & route data and the downloading of the bit stream into FPGA 41 or ROM 42. In this procedure, the data-writing device monitors the current writing count permitted for the user, so that the purchasing contract does not turn out to be noneffective.

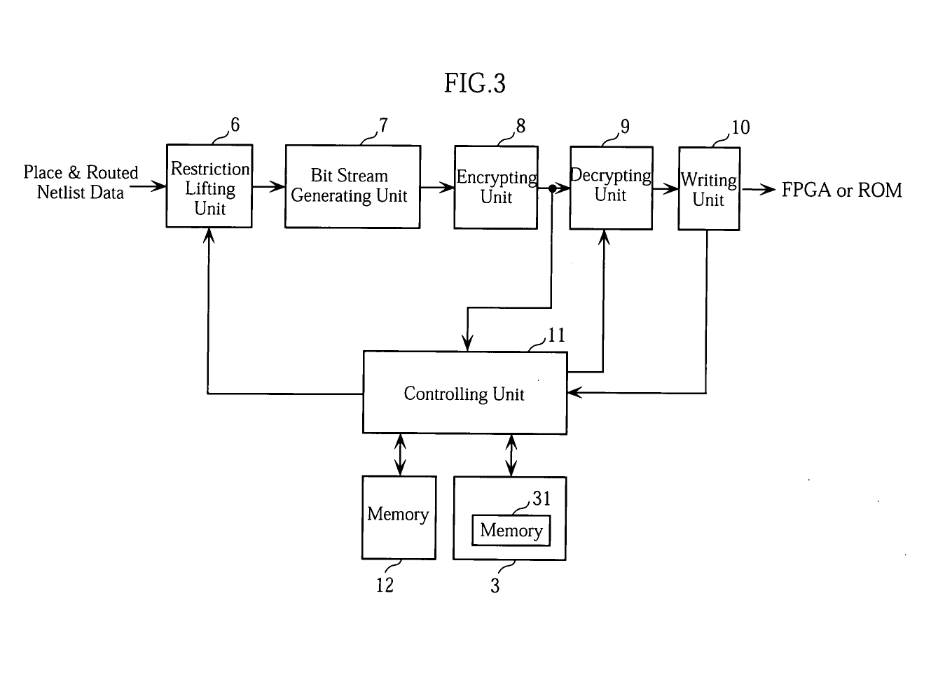

FIG. 3 is a block diagram illustrating the configuration of the data-writing device 1.

Basically, the data-writing device 1 includes a restriction-lifting unit (or section) 6, a bit stream-generating unit 7, an encryption unit 8, a decryption unit 9, a writing unit 10, a control unit 11, an internal memory 12 and a dongle 3. Each unit from the restriction-lifting unit 6 to the control unit 11 functions according to the CPU (central processing unit) executing a particular program. The internal memory 12 is the main storage device of the personal computer connected to the CPU, which is configured with RAMs (random access memories) and ROMs (read only memories). The grogram executed by the CPU are stored previously in the ROMs or downloaded into the RAMs from the external storage device 2 via a driver.

The dongle 3 has a connection terminal on one side for connection to a parallel port of the computer main body 1A. It also has connection terminals for tandem connection to other dongles on the other side. The dongle 3 has a memory 31 (flash memory, for example) for storing information for judgment of the appropriateness of the processing in the restriction-lifting unit 6 and the decryption unit 9 (“license information” about whether the use of the IP core is licensed by the IP vendor). The memory 31 also stores information about the permitted writing count of the IP netlist. When dongle 3 is connected to the computer main body 1A, the information is retrieved from the memory 31 to the RAM in the main body 1A to be used for judgment by the CPU (to be described below).

The restriction-lifting unit 6 lifts the functional restriction that has been previously imposed on the place & routed data prepared from the netlist for the FPGA 41. This netlist for the FPGA 41 may be a combination of two netlists: one is for the function-restricted IP core provided free of charge by the IP vendor and the other is the use's self-made netlist. Thus, the restriction imposed on the place & routed data is derived from the restriction imposed on the IP core supplied from the IP vendor. Examples of the functional restriction are temporal restriction whereby the IP core can normally function only for e.g. three months (counting from the supply date) unless the restriction lifting is not performed, or output power restriction (if the IP core is for communication purposes) whereby the maximum output power is made lower than the normal value unless the restriction lifting is not performed.

According to the present invention, the function-restricted place & routed data may be stored in an internal memory 12 (e.g., RAM) of the personal computer 1. In this case, the data is retrieved from the internal memory 12 and inputted into the restriction-lifting unit 6. When instructed to prohibit the lift of restriction by the control unit 11, the restriction-lifting unit 6 does not perform the restriction lifting for the place & routed data. When the control unit 11 finds that the license has expired based on the information retrieved from the dongle 3, the control unit instructs the restriction-lifting unit 6 to prohibit the restriction lifting.

The bit stream-generating unit 7 converts the restriction-lifted place & routed data to a series of bit data (namely, bit stream) that is writable to the FPGA 41 or to the ROM 42. A special program provided by the FPGA vendor may be used for causing the bit stream-generating unit 7 to perform the required processing. The resultant bit stream is outputted to the encryption unit 8.

The encryption unit 8 encrypts the bit stream. Any one of known encryption methods including secret-key encryption may be used for the encryption. The encrypted bit stream is stored in the internal memory 12, and the user can access the stored bit stream. With such an arrangement, for example, the user can retrieve the encrypted bit stream from the memory 12 for decryption, and then write the decrypted bit stream to a different FPGA 41 or ROM 42 by using the data-writing device 1.

As noted above, the bit stream is placed under the control of the user. This is because it would take an elongated period of time if the function-restricted place & routed data is converted to the bit stream every time when the IP netlist is downloaded into FPGA 41 or ROM 42. In particular, when mass production is desired, it would take a lot of time to download the IP netlist into numerous FPGAs 41 or ROMs 42. This is not convenient for the user. On the other hand, if the user is allowed to manage the bit stream in the form that the IP netlist can be downloaded into FPGA 41, the user may use and copy the IP netlist in an unauthorized manner. For prevention of improper use on the side of the users, the encrypted bit streams are placed under the control of the user.

The decryption unit 9 decrypts the encrypted bit stream into a bit stream writable to the FPGA 41. When the control unit 11 instructs to prohibit decryption, the decryption unit 9 does not decrypt the encrypted bit stream. If the control unit 11 judges from the information retrieved from the dongle 3 that the license has expired or the permitted writing count is 0, the control unit instructs the decryption unit 9 to prohibit decryption.

The writing unit 10 downloads the bit stream output from the decryption unit 9 onto the FPGA 41 or the ROM 42. If the encrypted bit stream is not decrypted in the decryption unit 9, the encrypted bit stream is not downloaded into the FPGA 41 or the ROM 42. The writing unit 10 writes the bit stream, and if the writing is successful, the information is sent to the control unit 11, and the current permitted writing count n′ of the bit stream is calculated in the control unit 11. That is, a remaining permitted writing count n′ (n−1) is calculated by subtracting 1 from the permitted writing count n retrieved from the dongle 3.

The control unit 11 controls the processing in each unit from the restriction-lifting unit 6 to the writing unit 10, and manages the writing count n for writing the bit stream to the FPGA 41 or the ROM 42. As described above, the control unit 11 retrieves the information about the license and the permitted writing count from the memory 31 in the dongle 3 and judges the appropriateness of the lift of functional restriction on the function-restricted IP netlist and the decryption of the encrypted bit stream based on the license information and the information about the permitted writing count. If the license has already expired, the control unit issues an instruction prohibiting the lift of the functional restriction to the restriction-lifting unit 6, and if license has expired or the permitted writing count is 0, issues an instruction prohibiting decryption to the decryption unit 9. In this manner, writing of the function-restricted place & routed data to the FPGA 41 or ROM 42 is prohibited.

Further, when the information about the completion of writing in the writing unit 10 is input, the control unit recalculates the remaining permitted writing count of the function-restricted place & routed data onto the FPGA 41 or the ROM 42. The current permitted writing count n (first permitted writing count−integrated writing count=current permitted writing count) is stored in the memory 31 in the dongle 3, and the control unit 11 calculates the remaining permitted writing count n′ by subtracting 1 from the current permitted writing count n retrieved from the dongle 3, and replaces the permitted writing count n stored in the memory 31 in the dongle 3 with this permitted writing count n′.

Alternatively, the control unit 11 may judge the appropriateness of decryption by calculating integrated writing count every time when data are written and comparing the integrated count with the bought permitted writing count.

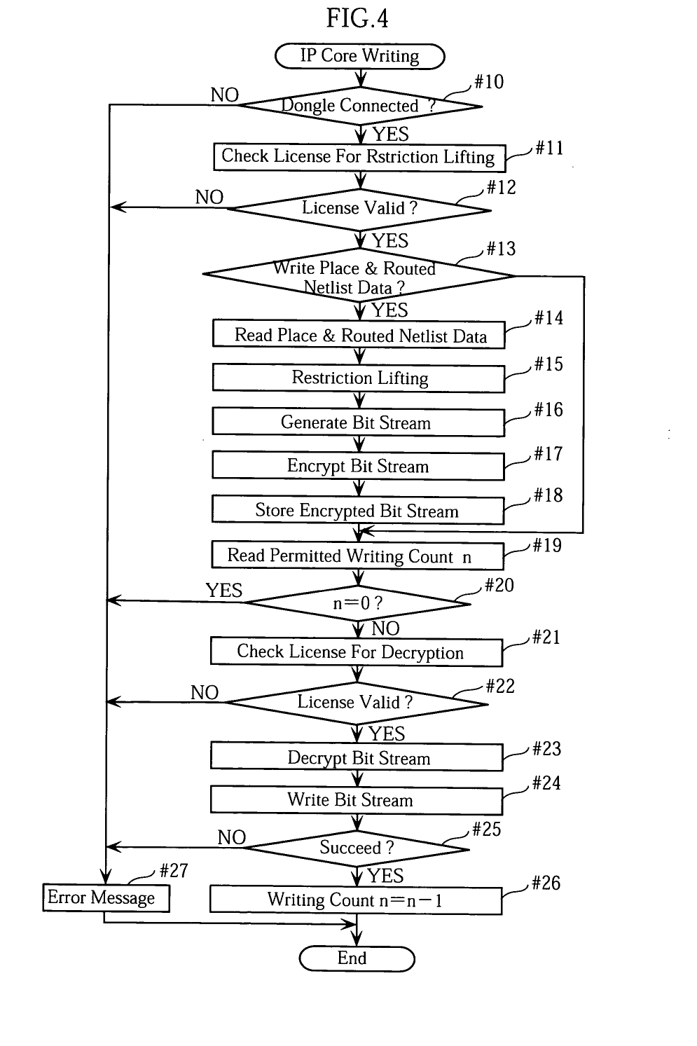

Hereinafter, information writing in the data-writing device 1 according to the present invention will be described with reference to the flow chart shown in FIG. 4.

For writing information, data to be written should be specified. The data include the function-restricted place & routed data and the encrypted bit stream generated when the information is written.

First, it is confirmed whether the dongle 3 is connected to the data-writing device 1 (#10). The judgment is made by examining whether the control unit 11 can reads the information about the license and the permitted writing count stored in the memory 31 in the dongle 3. If the dongle 3 is not connected (#10: NO), a particular error message is displayed in the display device 1B (#25) and the information writing is terminated. The error message is for example a message that informs disconnection of the dongle 3 or that suggests the user to connect the dongle 3.

If the dongle 3 is connected (#10: YES), the license information is retrieved from the dongle 3, and it is decided whether the license of lifting the functional restriction is valid (#11 and #12). Namely, it is confirmed whether the lift of restriction is approved. If the license of the lift of functional restriction is invalid (#12: NO), a particular error message is displayed in the display device 1B in step #27 and the information writing is terminated. The error message is for example a message that informs that the license of the lift of restriction is invalid or that suggests the user to obtain the license of the lift of restriction.

On the contrary, if the license of the lift of restriction is valid (#12: YES), it is judged whether the data to be written is function-restricted place & routed data or an encrypted bit stream (#13). If the data is the function-restricted data (#13: YES), the function-restricted data is retrieved from a certain file stored in the internal memory 12 or the external storage medium 2 (#14). Subsequently, restricted functions in the function-restricted place & routed data are unfrozen (#15).

Then, a bit stream is generated from the place & routed data from which restricted functions are unfrozen (#16) and the bit stream is encrypted (#17) and then stored in the internal memory 12 (#18). The information about the permitted writing count then is read (#19); it was judged whether the remaining permitted writing count n is 0 (#20); if n=0 (#20: YES), a particular error message is displayed in the display device 1B in step #27 and the information writing is terminated. The error message is for example a message that informs that the permitted writing count is 0 or that suggests the user to obtain the permitted writing count.

In this embodiment, the remaining permitted writing count n is recalculated every time when the bit stream is written on the FPGA 41 or ROM 42, and the calculation result is stored in the memory 31 in the dongle 3 over the old permitted writing count, but alternatively, the integrated writing count, which is calculated every time when the bit stream is written on the FPGA 41 or ROM, may be stored in the memory 31 in the dongle 3 over the old integrated writing count. In such a case, it is judged whether the integrated writing count N is identical with the permitted writing count n or whether the permitted writing count calculated by the formula (n−N) is 0 in step #20.

If n is not 0 in step #20 (#20: NO), the license of decryption is valid (#21), while if the license of decryption is invalid (#22: NO), a particular error message is displayed in the display device 1B in step #27 and the information writing is terminated. The error message is for example a message that informs that the license of decryption is invalid or that suggests the user to obtain the license of decryption.

On the other hand, if the license of decryption is valid (#22: YES), the encrypted bit stream is decrypted into the original bit stream (#23) and then written to the FPGA 41 or ROM 42 (#24). Subsequently, when writing of the bit stream is completed, it is confirmed whether the bit stream is written normally (#25), and if the writing is abnormal (#25: NO), a particular message is shown in the display device 1B in step #27 and the information writing is terminated. The error message is for example a message that informs that the data writing is abnormal or that suggest the user to repeat the information writing.

On the contrary, if the bit stream is written normally (#25: YES), a new remaining permitted writing count n′ is obtained by subtracting 1 from the information about the permitted writing count retrieved from the dongle 3, i.e., the currently remaining permitted writing count n (integrated value), and the permitted writing count n stored in the memory 31 in the dongle 3 is overwritten by the calculated value n′ (#26) and the information writing is completed.

If the encrypted bit stream is specified to be written in step #13, (#13: NO), as the information writing is already completed in processing in steps #14 to #18, the processing after the decryption step of step #19 is carried out, skipping these steps.

In the embodiment above, both of the licenses of decryption and the permitted writing count are confirmed for judging the appropriateness of decryption, but the appropriateness of decryption may be judged only by the permitted writing count.

As described above, the data-writing device according to the embodiment has a function to lift the functional restriction of the function-restricted place & routed data by using the function-restricted IP netlist provided by the IP vendor to the user free of charge at the time of contract as well as a controlling function to allow the function for the permitted writing count of times, and thus the IP vendor can effectively prevent unauthorized use of the IP core sold by using the data-writing device when the IP vendor and the user enter into an actual contract concerning the IP core (purchasing contract). As a result, the IP vendor can provide the IP core to the user without anxiety at the price decided based on the number of use, allowing reduction in the price of IP core, i.e., providing the IP core at a rate comparative to that of commercially available IC chips. In addition, the user can purchase various IP cores at a reasonable price, allowing decrease in the burden of designing and the cost of the products employing the FPGA, and consequently efficient utilization of the IP core.

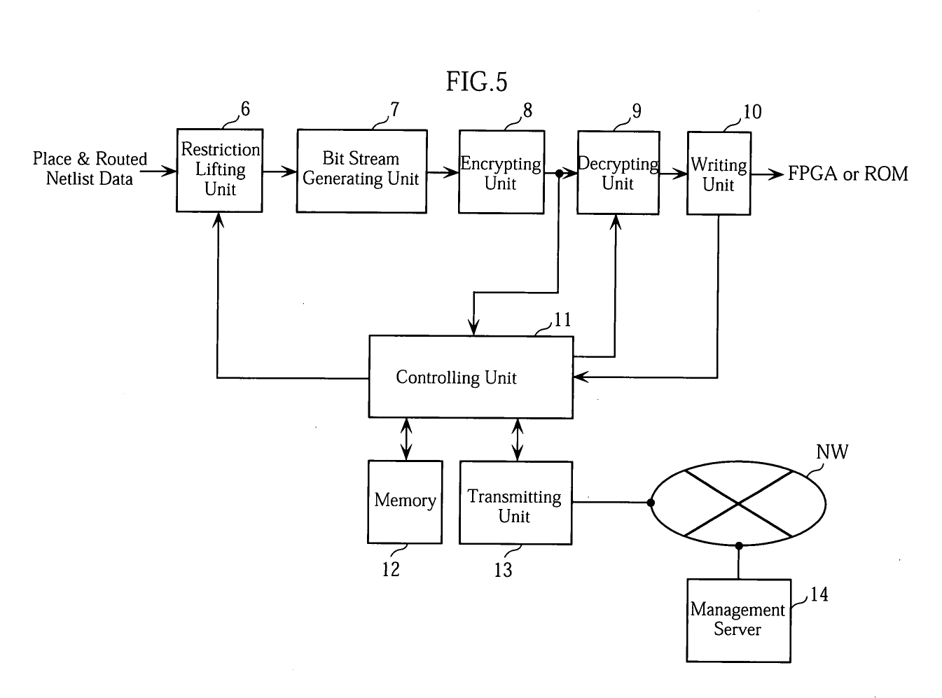

In the above embodiment, writing of the place & routed data to the FPGA 41 or ROM 42 is controlled by the dongle 3. However, the function of the dongle 3 may be carried out instead by a management server 14 placed in a network NW as shown in FIG. 5. In this configuration (the second embodiment), the control unit 11 retrieves via the communication control unit 13 the information about the license and the permitted writing count from the management server 14 in the network NW, recalculate the remaining permitted writing count every time when the writing is conducted, and sends the calculated value to the management server 14.

In the configuration of second embodiment, the information about the license and the permitted writing count is managed by the management server 14, and such a configuration is advantageous for the IP vendor, as it can monitor the use of the IP core by the user more easily.

In the embodiment above, the bit stream is first encrypted and the encrypted bit stream is stored in the internal memory 12. This is for effectively preventing unauthorized use or copying by the user as the bit stream is left under the control of the user, and alternatively the bit stream generated may be downloaded directly in the FPGA 41 or ROM 42 without encryption and decryption.

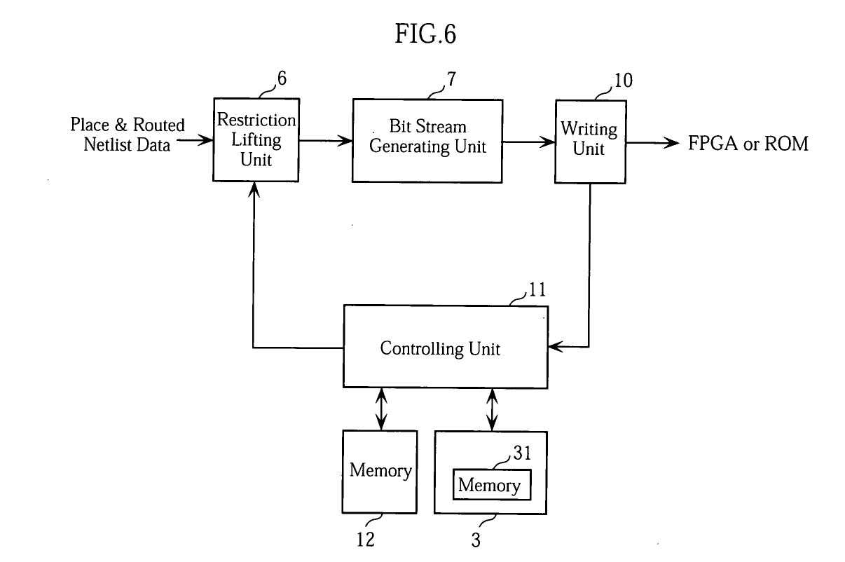

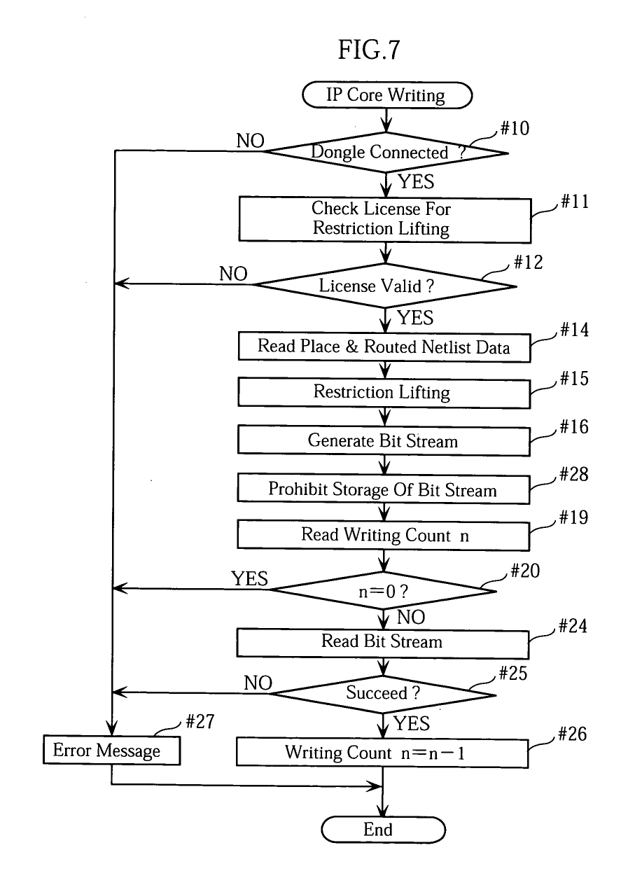

That is, the information may be processed in the configuration shown in FIG. 6 wherein the encryption unit 8 and the decryption unit 9 in FIG. 3 are removed (the third embodiment) according to the flow chart shown in FIG. 7. In the flow chart shown in FIG. 7, steps #13, #17, and #21 to #23 in FIG. 4 are removed and a step for prohibiting the storage of the bit stream in the internal memory 12, the external storage device 2, or the like (step #28) is added after step #16, for prevention of unauthorized use of the bit stream generated.

In the configuration of the third embodiment, the configuration is much simpler as it does not contain encryption and decryption steps. In addition, unauthorized use or copying of the bit stream can be prevented more efficiently, as the bit stream is not placed under the control of the user.

Further, in the embodiment above, the data-writing device 1 is an independent device conducting a series of processing from generation of a bit stream from the place & routed data after the lift of the functional restriction of the functionally-restricted place & routed data to download thereof onto the FPGA 41 or ROM 42. Alternatively, the device may be constituted by two separate devices, that is, a first device (the “data-generating device” below) responsible for production of encrypted bit steams starting from the function-restricted place & routed data, and a second device (“second data-writing device”) responsible for decryption of the encrypted bit streams and for writing the decrypted data to the FPGA 41 or ROM 42.

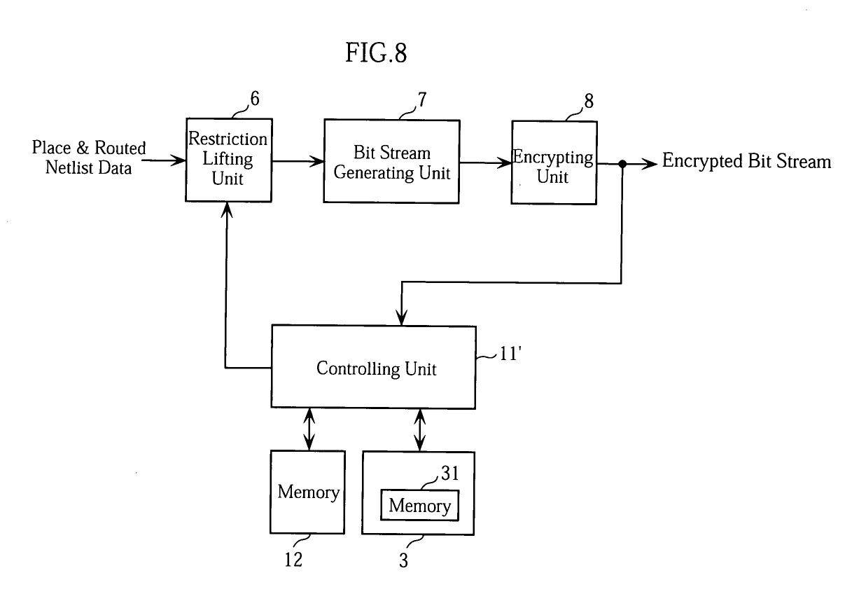

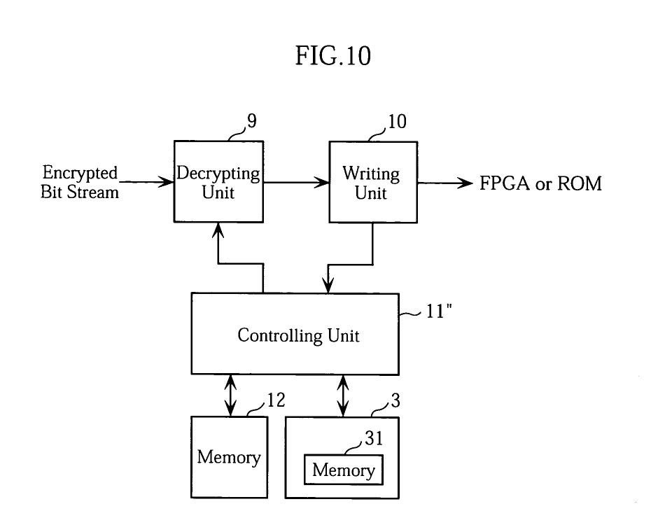

FIG. 8 is a diagram illustrating a configuration of the data-generating device. FIG. 10 is a diagram illustrating a configuration of the second data-writing device for writing the encrypted bit stream generated in the data-generating device on FPGA 41 or ROM 42.

The data-generating device shown in FIG. 8 is a device wherein the decryption unit 9 and the writing unit 10 are removed from the device shown in FIG. 4. Description of the functions of the units from the restriction-lifting unit 6 to the encryption unit 8 is curtailed, as they are already described above. The control unit 11′ has functions of managing each of the units from the restriction-lifting unit 6 to the encryption unit 8 in the control unit 11 shown in FIG. 4 and storing the encrypted bit stream output from the encryption unit 8 in the internal memory 12.

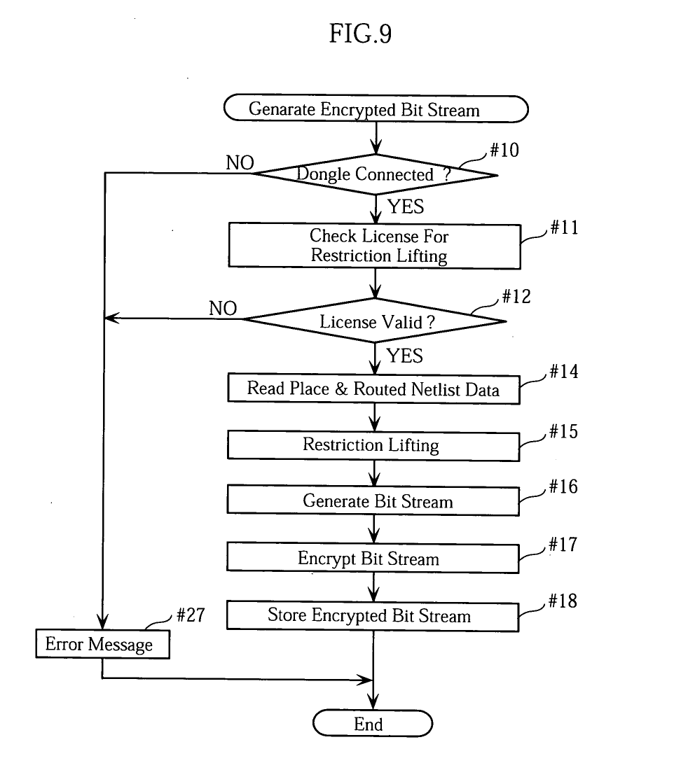

FIG. 9 is a flow chart illustrating the procedures of generating the encrypted bit stream in the data-generating device. The flow chart shown in the figure is a flow chart wherein the steps of decrypting the encrypted bit stream and storing the decrypted bit stream in the FPGA 41 or ROM 42, specifically, step #13 and steps #19 to #26 are removed from the flow chart shown in FIG. 4.

In the data-generating device, the data processed is only the function-restricted place & routed data, and thus the data processed is not selected when an encrypted bit stream is generated in the data-generating device. Thus, the judgment in step #13 is removed.

According to the flow chart shown in FIG. 9, it is confirmed first whether the dongle 3 is connected to the data-writing device 1 (#10). If the dongle 3 is unconnected (#10: NO), a particular error message is displayed in the display device 1B (#27) and the processing is terminated. The error message is for example a message that informs that the dongle 3 is unconnected or that prompts the user to connect the dongle 3.

If the dongle 3 is connected (#10: YES), the license information is retrieved from the dongle 3 (#11), and it is confirmed whether the license is valid (#12). Namely, it is confirmed whether the lift of restriction is approved. If the license is invalid (#12: NO), a certain error message is displayed in the display device 1B in step #27 and the processing is terminated. The error message is for example a message that informs that the license is invalid or that suggests the user to obtain the license.

On the contrary, if the license is valid (#12: YES), the function-restricted data is retrieved from the certain files stored in the internal memory 12 or the external storage medium 2 (#14). Subsequently, the restricted functions of the function-restricted place & routed data are removed (#15). Then, a bit stream is generated from the functional restriction-removed place & routed data (#16), and the bit stream is encrypted (#17) and stored in the internal memory 12 (#18), and the processing is terminated.

Alternatively, the second data-writing device shown in FIG. 10 is a device wherein the units from the restriction-lifting unit 6 to the encryption unit 8 are removed from the device shown in FIG. 4. Description of the functions of the decryption unit 9 and the writing unit 10 are curtailed as they are described above. The control unit 11″ has functions of controlling each of the decryption unit 9 and the writing unit 10 in control unit 11 shown in FIG. 4, and calculating the remaining permitted writing count n every time when the data is written to the writing unit 10, and storing the calculated value in the memory 31 in the dongle 3 over the old permitted writing count.

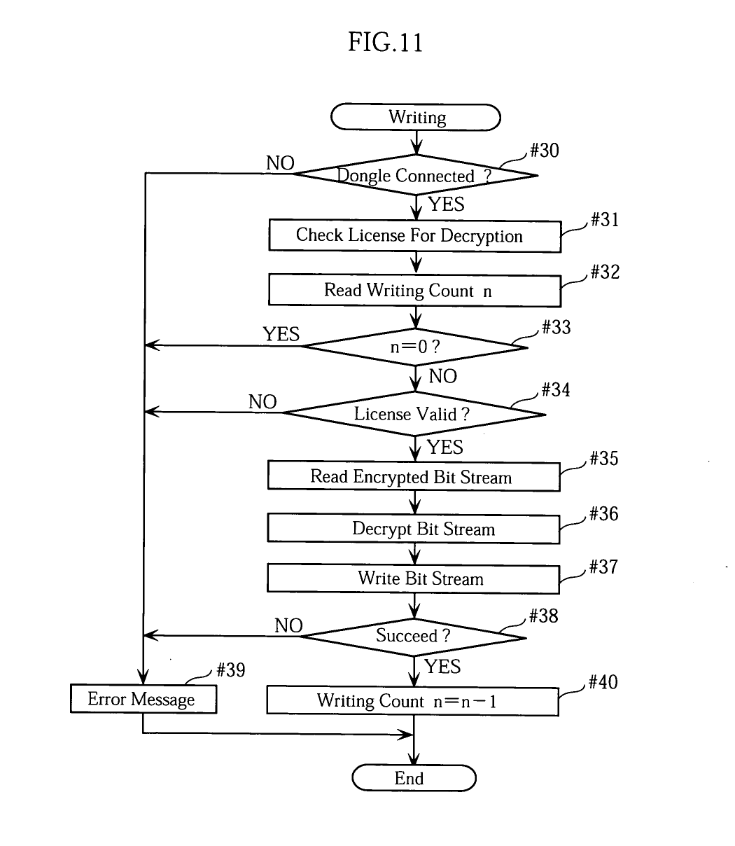

FIG. 11 is a flow chart illustrating the processing procedures in the second data-writing device wherein the encrypted bit stream generated in the data-generating device is written on an FPGA or ROM. In the second data-writing device, the data processed is only the encrypted bit stream and thus the data processed is not selected during information writing.

In the flow chart shown in FIG. 11, it is confirmed first whether the dongle 3 is connected to the second data-writing device (#30). If the dongle 3 is unconnected (#30: NO), a certain error message is displayed in the display device 1B (#39) and the processing is terminated. The error message is for example a message that informs that the dongle 3 is unconnected or that suggest the user to connect the dongle 3.

If the dongle 3 is connected (#30: YES), it is confirmed whether the license of decryption is valid (#31), and the information about the permitted writing count is retrieved (#32) Then, it is confirmed whether the permitted writing count n is 0 (#33), and if n=0 (#33: YES), a particular error message is displayed in the display device 1B in step #39 and the processing is terminated. The error message is for example a message that informs that the permitted writing count is 0 or that suggests the user to obtain the permitted writing count.

If n is not 0 in step #33 (#33: NO), it is additionally confirmed whether the license of decryption is valid (#34). If the license of decryption is invalid (#34: NO), a particular error message is displayed in the display device 1B in step #39 and the processing is terminated. The error message is for example a message that informs that the license is invalid or that suggests the user to obtain the license.

On the contrary, if the license of decryption is valid (#34: YES), the encrypted bit stream is retrieved from a certain file stored in the internal memory 12 or the external storage medium 2 (#35). Then, the encrypted bit stream is decrypted into the original bit stream (#36), which is written to the FPGA 41 or ROM 42 (#37). Subsequently, after completion of the bit stream writing, it is confirmed whether the bit stream is written normally (#38), and if the writing is abnormal (#38: NO), a particular error message is displayed in the display device 1B in step #39 and the processing is terminated. The error message is for example a message that informs that the data is written abnormally, or that suggest the user to repeat the writing procedure.

On the contrary, if the bit stream is written normally (#38: YES), a new remaining permitted writing count n′ is calculated by subtracting 1 from the information about the permitted writing count retrieved from the dongle 3, i.e., current remaining permitted writing count n (integrated value), and the permitted writing count n stored in the memory 31 in the dongle 3 is replaced with the calculated value n′ (#40), and the processing is terminated.

In the flow chart shown in FIG. 11, the validity of both the license and the permitted writing count are examined for making a judgment on whether the steps after decryption of the encrypted bit stream are to be conducted, but alternatively, the judgment may be made by examining only one of them.

A configuration wherein the data-writing device according to the first embodiment is divided into a data-generating device generating an encrypted bit stream and the second data-writing device for writing the encrypted bit stream generated in the data-writing device to the FPGA 41 or ROM 42 may provide the advantageous effects similar to those by the data-writing device according to the first embodiment above.

In the description above, a configuration wherein the data-generating device is a user's personal computer is described, but the data-generating device may be installed in a management server 14 connected to a network shown in FIG. 5, or the license information is controlled by the dongle 3 and only the data-generating device is installed in the management server 14.

In such a configuration, the encrypted bit stream is generated from the function-restricted place & routed data by the management server 14. That is, the user sends the function-restricted place & routed data and the license information first to the management server 14. On receiving the function-restricted place & routed data and the license information, the management server 14 judges the appropriateness of generating an encrypted bit stream based on the license information, and if the generation of the encrypted bit stream is appropriate, generates and sends the encrypted bit stream to the personal computer of the user. On the contrary, if the generation of encrypted bit stream is not approved, the management server sends information that the generation of encrypted bit stream is rejected to the personal computer of the user.

On receiving the encrypted bit stream, the user's personal computer stores the data in the internal memory 12, and on receiving the information that the encrypted bit stream generation is not allowed, the computer displays a message corresponding to the information in the display device 1B. The processing in the steps from receiving the encrypted bit stream to writing the encrypted bit stream to the FPGA 41 or ROM 42 is conducted in the second data-writing device shown in FIG. 10 described above.

A data-generating device using the management server 14 is more advantageous, as the IP vendor can prevent more efficiently the unauthorized use or copying of IP netlists by users.

In the embodiment above, use of the personal computer 1 as a data-writing device, the second data-writing device, and a data-generating device, by installing the FPGA-write-only program stored in an external storage medium 2 such as CD-ROM and applying the external storage medium 2 and the dongle 3 to the user's personal computer 1 for protection of the program, is described, but alternatively, a data-writing device 1 having the configuration shown in FIG. 5, a data-generating device shown in FIG. 8, or the second data-writing device shown in FIG. 10 may be constructed by supplying the FPGA-write-only program from a management server 14 via a network NW to the user's personal computer 1. Alternatively, the IP vendor may construct a dedicated data-writing device 1 or a dedicated data-generating device and the second data-writing device, and provide them to the user.

As described above, if applied as a tool when an IP vendor sells an IP core, the data-writing device, data-generating device, and second data-writing device according to the present invention can solve various problems associated with conventional methods of providing IP cores, such as inability of managing the number of using the IP core and preventing unauthorized use or copying, for example.

1. A data-generating device that generates logic information about an internal circuit of hardware having a reconfigurable internal circuit, the logic information being written to the hardware for causing the hardware to carry out a particular function, the data-generating device comprising:
a first information-input section for inputting configuration-wiring information about configuration and wiring of the internal circuit, the configuration-wiring information being prepared in a state where part of the particular function is restricted;
a restriction-lifting section for lifting functional restriction of the configuration-wiring information;
an information-generating section for generating hardware-writable information based on the configuration-wiring information, the hardware-writable information being written to the hardware after the functional restriction is lifted;
an encryption section for encrypting the hardware-writable information;
a storage section for storing the encrypted hardware-writable information;
a second information-input section for inputting restriction control information being related to permission of restriction lifting for the functional restriction;
a judgment section for judging appropriateness of lifting the functional restriction by the restriction-lifting section based on the restriction control information; and
a prohibiting section for prohibiting the lifting of the functional restriction by the restriction-lifting section when the judgment section decides that the lifting is impermissible.

2. The data-generating device according to claim 1, wherein the restriction control information is stored in a hardware key externally connected to the second information-input section to be inputted to the second information-input section from the hardware key.

3. The data-generating device according to claim 1, wherein the restriction control information is stored in a management server placed on a network connected to the second information-input section, the restriction control information being inputted to the second information-input section from the management server by communication.

4. A data-writing device for causing the hardware-writable information generated by the data-generating device according to claim 1 to be written to a selected one of the hardware and a storage device separate from the hardware, the data-writing device comprising:
a first information-input section for imputing the encrypted hardware-writable information;
a decryption section for decrypting the encrypted hardware-writable information;
an information-writing section for writing the decrypted hardware-writable information to the selected one of the hardware and the storage device;
a second information-input section for inputting decryption control information and permitted writing count information, the decryption control information being related to permission of the decrypting by the decryption section, the permitted writing count information being related to a number of times for the hardware-writable information to be written to the hardware or the storage device;
a calculating section for calculating a remaining writing count based on the permitted writing count information, the calculation being performed every time the information-writing section performs writing of the hardware-writable information;
a judgment section for judging appropriateness of decryption by the decryption section based on the inputted decryption control information and the remaining writing count; and
a prohibiting section for prohibiting the decryption by the decryption section when the judgment section decides that the decryption is impermissible.

5. The data-writing device according to claim 4, further comprising a hardware key and an overwriting section, the hardware key being externally connected to the second information-input section, the overwriting section being provided for overwriting data stored in the hardware key, wherein the hardware key stores the decryption control information and the permitted writing count information both inputted to the second information-input section, the overwriting section being provided for overwriting the permitted writing count information stored in the hardware key with the calculated remaining writing count.

6. The data-writing device according to claim 4, further comprising a transmitting section, wherein the decryption control information and the permitted writing count information both inputted to the second information-input section are stored in a management server placed on a network connected to the second information-input section, and wherein the transmitting section transmits the calculated remaining writing count to the management server for overwriting the permitted writing count information stored in the server with the calculated remaining writing count.

7. A data-writing device for writing logic information about an internal circuit of hardware having a reconfigurable internal circuit, the logic information being written for causing the hardware to carry out a particular function, the data-writing device comprising:
a first information-input section for inputting configuration-wiring information about configuration and wiring of the internal circuit, the configuration-wiring information being prepared in a state where part of the particular function is restricted;
a restriction-lifting section for lifting functional restriction of the configuration-wiring information;
an information-generating section for generating hardware-writable information based on the configuration-wiring information, the hardware-writable information being written to the hardware after the functional restriction is lifted;
an information-writing section for writing the hardware-writable information to a selected one of the hardware and a storage device separate from the hardware;
a second information-input section for inputting restriction control information and permitted writing count information, the restriction control information being related to permission of restriction lifting for the functional restriction, the permitted writing count information being related to a number of times for the hardware-writable information to be written to the hardware or the storage device;
a calculating section for calculating a remaining writing count based on the permitted writing count information inputted to the second information-input section, the calculation being performed every time the information-writing section performs writing of the hardware-writable information;
ajudgment section for judging appropriateness of lifting the functional restriction by the restriction-lifting section based on the restriction control information and the remaining writing count; and
a prohibiting section for prohibiting the lifting of the functional restriction by the restriction-lifting section when the judgment section decides that the lifting is impermissible.

8. A data-writing device for writing logic information about an internal circuit of hardware having a reconfigurable internal circuit, the logic information being written for causing the hardware to carry out a particular function, the data-writing device comprising:
a first information-input section for inputting configuration-wiring information about configuration and wiring of the internal circuit, the configuration-wiring information being prepared in a state where part of the particular function is restricted;
a restriction-lifting section for lifting functional restriction of the configuration-wiring information;
an information-generating section for generating hardware-writable information based on the configuration-wiring information, the hardware-writable information being written to the hardware after the functional restriction is lifted;
an encryption section for encrypting the hardware-writable information;
a storage section for storing the encrypted hardware-writable information;
a decryption section for decrypting the encrypted hardware-writable information;
an information-writing section for writing the decrypted hardware-writable information to the hardware or a storage device separate from the hardware;
a second information-input section for imputing control information and permitted writing count information, the control information being related both to permission of restriction lifting for the functional restriction by the restriction-lifting section and to permission of the decrypting by the decryption section, the permitted writing count information being related to a number of times for the hardware-writable information to be written to the hardware or the storage device;
a calculating section for calculating a remaining writing count based on the permitted writing count information every time the information-writing section performs writing of the hardware-writable information;
a judgment section for judging appropriateness of the lifting of the functional restriction by the restriction-lifting section and appropriateness of the decrypting by the decryption section based on the control information and the remaining writing count; and
a prohibiting section for prohibiting the lifting of the functional restriction by the restriction-lifting section and the decrypting by the decryption section when the judgment section decides that the lifting and the decrypting are impermissible.

9. The data-writing device according to claim 7, further comprising a hardware key and an overwriting section, the hardware key being externally connected to the second information-input section, the overwriting section being provided for overwriting data stored in the hardware key, wherein the hardware key stores the control information and the permitted writing count information both inputted to the second information-input section, the overwriting section being provided for overwriting the permitted writing count information stored in the hardware key with the calculated remaining writing count.

10. The data-writing device according to claim 7, further comprising a transmitting section, wherein the control information and the permitted writing count information both inputted to the second information-input section are stored in a management server placed on a network connected to the second information-input section, and wherein the transmitting section transmits the calculated remaining writing count to the management server for overwriting the permitted writing count information stored in the server with the calculated remaining writing count.

11. A program for causing a computer to function as an data-generating device that generates logic information about an internal circuit of hardware having a reconfigurable internal circuit, the logic information being written to the hardware for causing the hardware to carry out a particular function, the program causing the computer to perform the functions of:
a first information-input section for inputting configuration-wiring information about configuration and wiring of the internal circuit, the configuration-wiring information being prepared in a state where part of the particular function is restricted;
a restriction-lifting section for lifting functional restriction of the configuration-wiring information;
an information-generating section for generating hardware-writable information based on the configuration-wiring information, the hardware-writable information being written to the hardware after the functional restriction is lifted;
an encryption section for encrypting the hardware-writable information;
a storage section for storing the encrypted hardware-writable information;
a second information-input section for inputting restriction control information being related to permission of restriction lifting for the functional restriction;
a judgment section for judging appropriateness of lifting the functional restriction by the restriction-lifting section based on the restriction control information; and
a prohibiting section for prohibiting the lifting of the functional restriction by the restriction-lifting section when the judgment section decides that the lifting is impermissible.

12. A program for causing a computer to function as a data-writing device for causing the hardware-writable information generated by the data-generating device according to claim 1 to be written to a selected one of the hardware and a storage device separate from the hardware, the program causing the computer to perform the functions of:
a first information-input section for imputing the encrypted hardware-writable information;
a decryption section for decrypting the encrypted hardware-writable information;
an information-writing section for writing the decrypted hardware-writable information to the selected one of the hardware and the storage device;
a second information-input section for inputting decryption control information and permitted writing count information, the decryption control information being related to permission of the decrypting by the decryption section, the permitted writing count information being related to a number of times for the hardware-writable information to be written to the hardware or the storage device;
a calculating section for calculating a remaining writing count based on the permitted writing count information, the calculation being performed every time the information-writing section performs writing of the hardware-writable information;
a judgement section for judging appropriateness of decryption by the decryption section based on the inputted decryption control information and the remaining writing count; and
a prohibiting section for prohibiting the decryption by the decryption section when the judgment section decides that the decryption is impermissible.

13. The program according to claim 12, further causing the computer to perform the function of a data-overwriting section, wherein the data-overwriting section cooperates with a hardware key that is externally connected to the second information-input section and stores the decryption control information and the permitted writing count information, the data-overwriting section functioning to overwrite the permitted writing count information stored in the hardware key with the calculated remaining writing count.

14. The program according to claim 12, further causing the computer to perform the function of a transmitting section, wherein the transmitting section cooperates with a management server that is placed on a network connected to the second information-input section and stores the decryption control information and the permitted writing count information, the transmitting section transmits the calculated remaining writing count to the management server for overwriting the permitted writing count information stored in the server with the calculated remaining writing count.

15. A program for causing a computer to function as a data-writing device for writing logic information about an internal circuit of hardware having a reconfigurable internal circuit, the logic information being written for causing the hardware to carry out a particular function, the program causing the computer to perform the functions of:
a first information-input section for inputting configuration-wiring information about configuration and wiring of the internal circuit, the configuration-wiring information being prepared in a state where part of the particular function is restricted;
a restriction-lifting section for lifting functional restriction of the configuration-wiring information;
an information-generating section for generating hardware-writable information based on the configuration-wiring information, the hardware-writable information being written to the hardware after the functional restriction is lifted;
an information-writing section for writing the hardware-writable information to a selected one of the hardware and a storage device separate from the hardware;
a second information-input section for inputting restriction control information and permitted writing count information, the restriction control information being related to permission of restriction lifting for the functional restriction, the permitted writing count information being related to a number of times for the hardware-writable information to be written to the hardware or the storage device;
a calculating section for calculating a remaining writing count based on the permitted writing count information inputted to the second information-input section, the calculation being performed every time the information-writing section performs writing of the hardware-writable information;
a judgment section for judging appropriateness of lifting the functional restriction by the restriction-lifting section based on the restriction control information and the remaining writing count; and
a prohibiting section for prohibiting the lifting of the functional restriction by the restriction-lifting section when the judgment section decides that the lifting is impermissible.

16. A program for causing a computer to function as a data-writing device for writing logic information about an internal circuit of hardware having a reconfigurable internal circuit, the logic information being written for causing the hardware to carry out a particular function, the program causing the computer to perform the functions of:
a first information-input section for inputting configuration-wiring information about configuration and wiring of the internal circuit, the configuration-wiring information being prepared in a state where part of the particular function is restricted;
a restriction-lifting section for lifting functional restriction of the configuration-wiring information;
an information-generating section for generating hardware-writable information based on the configuration-wiring information, the hardware-writable information being written to the hardware after the functional restriction is lifted;
an encryption section for encrypting the hardware-writable information;
a storage section for storing the encrypted hardware-writable information;
a decryption section for decrypting the encrypted hardware-writable information;
an information-writing section for writing the decrypted hardware-writable information to the hardware or a storage device separate from the hardware;
a second information-input section for imputing control information and permitted writing count information, the control information being related both to permission of restriction lifting for the functional restriction by the restriction-lifting section and to permission of the decrypting by the decryption section, the permitted writing count information being related to a number of times for the hardware-writable information to be written to the hardware or the storage device;
a calculating section for calculating a remaining writing count based on the permitted writing count information every time the information-writing section performs writing of the hardware-writable information;
a judgment section for judging appropriateness of the lifting of the functional restriction by the restriction-lifting section and appropriateness of the decrypting by the decryption section based on the control information and the remaining writing count; and
a prohibiting section for prohibiting the lifting of the functional restriction by the restriction-lifting section and the decrypting by the decryption section when the judgment section decides that the lifting and the decrypting are impermissible.

17. The program according to claim 15, further causing the computer to perform the function of a data-overwriting section, wherein the data-overwriting section cooperates with a hardware key that is externally connected to the second information-input section and stores the control information and the permitted writing count information, the data-overwriting section functioning to overwrite the permitted writing count information stored in the hardware key with the calculated remaining writing count.

18. The program according to claim 15, further causing the computer to perform the function of a data-transmitting section, wherein the data-transmitting section cooperates with a management server that is placed on a network connected to the second information-input section and stores the control information and the permitted writing count information, the data-transmitting section functioning to transmit the calculated remaining writing count to the management server for overwriting the permitted writing count information stored in the server with the calculated remaining writing count.

19. A computer-readable recording medium storing the program according to claim 11.

20. The data-writing device according to claim 8, further comprising a hardware key and an overwriting section, the hardware key being externally connected to the second information-input section, the overwriting section being provided for overwriting data stored in the hardware key, wherein the hardware key stores the control information and the permitted writing count information both inputted to the second information-input section, the overwriting section being provided for overwriting the permitted writing count information stored in the hardware key with the calculated remaining writing count.

21. The data-writing device according to claim 8, further comprising a transmitting section, wherein the control information and the permitted writing count information both inputted to the second information-input section are stored in a management server placed on a network connected to the second information-input section, and wherein the transmitting section transmits the calculated remaining writing count to the management server for overwriting the permitted writing count information stored in the server with the calculated remaining writing count.

22. The program according to claim 16, further causing the computer to perform the function of a data-overwriting section, wherein the data-overwriting section cooperates with a hardware key that is externally connected to the second information-input section and stores the control information and the permitted writing count information, the data-overwriting section functioning to overwrite the permitted writing count information stored in the hardware key with the calculated remaining writing count.

23. The program according to claim 16, further causing the computer to perform the function of a data-transmitting section, wherein the data-transmitting section cooperates with a management server that is placed on a network connected to the second information-input section and stores the control information and the permitted writing count information, the data-transmitting section functioning to transmit the calculated remaining writing count to the management server for overwriting the permitted writing count information stored in the server with the calculated remaining writing count.

24. A computer-readable recording medium storing the program according to claim 15.

25. A computer-readable recording medium storing the program according to claim 16.
